(19) United States
(12) Patent Application Publication
(10) Pub. No.: US 2004/0025028 A1
(43) Pub. Date: Feb. 5, 2004

(54) Method, program, and apparatus for managing certification management environment

(75) Inventor: Takashi Takeuchi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/351,341

(22) Filed: Jan. 27, 2003

(30) Foreign Application Priority Data
Aug. 5, 2002 (JP) 2002-226947

(51) Int. Cl. H04L 9/00

(52) U.S. Cl. 713/184; 380/277; 713/155

(57) ABSTRACT

A unique user information character string is generated by a character string generation unit, and the user information character string is scribed by a user-personal identification number generation unit by coding performed by a manager secret key to generate a security officer-personal identification number (SO-PIN). Furthermore, a certification management environment of an IC card is accessed by a management operation unit by setting the security officer-personal identification number (SO-PIN) generated by the personal identification number generation unit to perform a management operation.

### BACKGROUND OF THE INVENTION

1. Technical Field

The present invention relates to a method, program, and apparatus for managing data of certification management environment of an IC card or the like by using two number, i.e., a user-personal identification number and a security officer-personal identification number as passwords and, more particularly, to a method, program, and apparatus for automatically generating the security officer-personal identification number to manage data of a certification management environment such as an IC card.

2. Description of the Related Arts

In realization of electronic commerce or administrative services, coding or authentication of a message is absolutely necessary to prevent interpolation of data by the third party or pretending to be an identical person. A technique for realizing this is a public key infrastructure (PKI). In the public key infrastructure, the certification (public key) of a communication destination is required to be shared, and a user must strictly manage her/his secret key in a certification management environment.

In the future, when a company or a group realizes a public key infrastructure (PKI), it is considered that a manager must store certifications and secret keys of respective users in, e.g., IC cards as certification management environments to deliver the IC cards to the user. Authentication of the IC card serving as a certification management environment to be distributed is performed by password authentication called a personal identification number (PIN). In this password authentication, a single-password scheme which sets only a user-personal identification number (User-PIN) for identifying a general user and a multi-password scheme which sets a security officer-personal identification number (SO-PIN) for identifying a manager and a user-personal identification number (User-PIN) for identifying a general user are used. The certification management environment of an IC card is divided into a public data area in which a certification or the like is stored and a private data area in which a secret key or the like is stored. In the private data area, data cannot be accessed unless password authentication is established by a user-personal identification number (User-PIN). In this case, a procedure for storing data in an IC card having a certification management environment of a single-password scheme is as follows.

Step 1: A manager logs in to an IC card by a default user-personal identification number (User-PIN).

Step 2: Store data such as a certification or a secret key in the IC card.

Step 3: Change the user-personal identification number (User-PIN) into an authentic user-personal identification number (User-PIN).

Step 4: Log-out

Step 5: Distribute the IC card and the user-personal identification number (User-PIN) to a user who demands the IC card and the user-personal identification number (User-PIN) through another route.

A procedure for storing data in a certification management environment of the multi-password scheme is as follows.

Step 1: A manager logs in to an IC card by a default security officer-personal identification number (SO-PIN).

Step 2: Initialize the IC card, i.e., set the security officer-personal identification number (SO-PIN) and a user-personal identification number (User-PIN) and delete or update data recorded on the IC card.

Step 3: Log-out

Step 4: The manager logs in to the IC card by the user-personal identification number (User-PIN).

Step 5: store data such as a certification or a secret key in the IC card.

Step 6: Change the user-personal identification number (User-PIN) into an authentic user-personal identification number (User-PIN).

Step 7: Log-out

Step 8: Distribute the IC card and the user-personal identification number (User-PIN) to a user who 10 demands the IC card and the user-personal identification number (User-PIN) through another route.

In any scheme, a user-personal identification number (User-PIN) demanded by a user in advance may be set in an IC card, and only the IC card is distributed.

The multi-password scheme has the following characteristic feature in comparison with the single-password scheme. Even if a user forgets the user-personal identification number (User-PIN), the user-personal identification number (User-PIN) can be reset by the authority of the manager using password authentication of the security officer-personal identification number (SO-PIN). For this reason, a user of data can be restarted. In particular, when there is a resource or a setting which is coded by a secret key stored in an IC card, these resources and settings need not be wasted. When a user-personal identification number (User-PIN) is erroneously and continuously input in an illegal access, a user-personal identification number (User-PIN) lock is established to prevent the illegal access. In addition, even though the certification management environment of the IC card is set in a user-personal identification number (User-PIN) lock state, the user-personal identification number (User-PIN) lock state can be canceled by the authority of the manager. For this reason, a user of data can be restarted. In addition, when a security officer-personal identification number (SO-PIN) is erroneously and continuously input in an illegal access, a security officer-personal identification number (SO-PIN) lock is established to prevent the illegal access.

However, in the conventional multi-password scheme, when a large number of IC cards are formed as certification management environments of general users, a security officer-personal identification number (SO-PIN) is uniformly set to efficiently perform the management operation. However, if the security officer-personal identification number (SO-PIN) is exposed, a user-personal identification number (User-PIN) of an IC card can be reset by the authority of the manager. For this reason, the third party can be pretended to be a general user. For this reason, the problem of the exposure of the security officer-personal identification number (SO-PIN) spread to not only a set of IC cards, but also all IC cards. In order to prevent this drawback, security officer-personal identification numbers (SO-PIN) the number of which is equal to the number of IC cards to be distributed must be set. When the security officer-personal identification numbers (SO-PIN) increases in number, the security officer-personal identification numbers (SO-PIN) cannot be easily formed and managed. In particular, when the number of IC cards increases, character strings having the same pattern tends to be frequently used as security officer-personal identification numbers (SO-PIN) set by a manager. However, when random character strings are set, the security officer-personal identification numbers (SO-PIN) are hardly manually managed by the manager. In addition, when security officer-personal identification numbers (SO-PIN) recorded on sheets of paper or files, a risk that the security officer-personal identification numbers (SO-PIN) are referred to by a person other than the manager. Furthermore, management of the security officer-personal identification numbers (SO-PIN) is left to the discretion of the manager to cause an increase in load on the manager and sloppy management.

### SUMMARY OF THE INVENTION

According to the present invention, there is provided a method, program, and apparatus for managing certification management environments which can easily manage security officer-personal identification numbers (SO-PIN) without lowering a security level even though the number of certification management environments such as IC cards is considerably large.

The present invention is a method of managing a certification management environment such as an IC card of a user in which a certification and a secret key are stored, including: the character string generation step of generating a unique user information character string by a character string generation unit; and the personal identification number generation step of subscribing the user information character string by coding performed by using a manager secret key by a personal identification number generation unit to generate a security officer-personal identification number (SO-PIN). According to the present invention, the method further includes the management operation step of accessing a certification management environment by setting the generated security officer-personal identification number (SO-PIN) by the management operation unit in the personal identification number generation step. For this reason, according to the management method of the present invention, since a security officer-personal identification number (SO-PIN) is automatically formed as a unique character string from a unique user information character string and signature data using a secret key of a card manager, security officer-personal identification numbers (SO-PIN) the number of which is required to be equal to the number of certification management environments of general users need not be managed, and the security officer-personal identification numbers (SO-PIN) need not be directly managed. A card manager may store only a secret key in an IC card, an HSM (Hardware Security Module), or the like to prevent the secret key from being exposed and may manage only the IC card or the like, so that the management can be safely and easily performed. When a manager performs a management operation by the authority of the manager by the certification management environment of a general user, the manager selects the entry of the general user and generates a coded security officer-personal identification number (SO-PIN) to use the security officer-personal identification number (SO-PIN) for a log-in of the manager to the certification management environment. These processes are automatically performed on a memory of a computer, and no security officer-personal identification number (SO-PIN) is manually input. For this reason, the management operation can be performed without letting the manager to know the security officer-personal identification number (SO-PIN), and the security officer-personal identification number (SO-PIN) can be reliably prevented from being exposed. In the character string generation step, a user identification character string is generated on the basis of a user certification extracted from a preset user certification file. For example, in the character string generation step, a subject representing a subject name in the user certification extracted from the preset user certification file is picked up as a user information character string. In addition, in the character string generation step, the user certification itself extracted from the preset user certification file may be generated as a user information character string. Furthermore, in the character string generation step, an input predetermined character string may be generated as the user information character string. For example, in the character string generation step, a character string of four pieces of information constituted by the input name, birth date, sex, and address of a user may be generated as the user information character string.

In this manner, the user information character string which is required to automatically generate a security officer-personal identification number (SO-PIN) according to the present invention may be acquired from a certification serving as a public key or acquired by an input by a manager. Since the user information character string is subscribed by coding by a manager secret key and converted into a security officer-personal identification number (SO-PIN), even if the user information character string is exposed, it is impossible to expose the security officer-personal identification number (SO-PIN).

In the character string generation step, a hash value is generated by a predetermined hash algorithm from a user information character string. In the personal identification number generation step, the hash value is subscribed by coding performed by using a manager secret key to generate a security officer-personal identification number (SO-PIN). In this manner, the user information character string is not directly used, and a hash value calculated by SHA-1 (also called sha1) or the like known as a hash algorithm is used, so that a security level can be increased.

In the personal identification number generation step, after the generated signature data is converted into a character string, a character string having a predetermined number of characters is cut from the converted character string to generate a security officer-personal identification number (SO-PIN). More specifically, according to the specification of the security officer-personal identification number (SO-PIN), in the personal identification number generation step, a character string having a predetermined number of characters which ranges 4 to 15 or 6 to 15 may be cut from the character string converted from the signature data to generate a security officer-personal identification number (SO-PIN).

In the management operation step, a log-in process to a certification management environment of a user is performed by the authority of the security officer-personal identification number (SO-PIN) and sets the security officer-personal identification number (SO-PIN) and a user-personal identification number (User-PIN) which is generated in advance in the certification management environment, and a certification and a secret key of the user acquired by decoding a preset file are stored by the authority of the user-personal identification number (User-PIN) in the certification management environment to perform a log-off process. For example, in the management operation step, a certification and a secret key of the user acquired by decoding a preset PKCS file and a preset PKCS password file are stored in the certification management environment to perform a log-off process. The certification management environment of the user is an IC card in which a security officer-personal identification number, a user-personal identification number, a user certification, and a user secret key are stored.

According to the present invention, there is provided a program for managing a certification management environment of a user in which a certification and a secret key are stored. This program causes a computer to execute: the character string generation step of generating a unique user information character string; and the personal identification number generation step of scribing the user information character string by coding performed by using a manager secret key to generate a security officer-personal identification number. Furthermore, the program further includes the management operation step of accessing the certification management environment by setting the generated security officer-personal identification number to perform a management operation.

According to the present invention, there is provided a management apparatus for managing a certification management environment of a user in which a certification and a secret key are stored. This management apparatus includes: a character string generation unit for generating a unique user information character string; and a personal identification number generation unit for scribing a user information character string by coding performed by using a manager secret key to generate a security officer-personal identification number. The management apparatus further includes a management operation unit for accessing the certification management environment by setting the generated security officer-personal identification number to perform a management operation. The details of the program and the management apparatus according to the present invention are basically the same as those of the management method described above.

The above and other objects, features, and advantages of the present invention will be become more apparent from the following detailed description with reference to the drawings.

### BRIEF DESCRIPTION OF THE DRAWINGS

FIG. 1 is a diagram for explaining a certification management environment maintenance system to which the present invention is applied.

FIG. 2 is a diagram for explaining a hardware environment of a computer to which the management apparatus in FIG. 1 is applied.

FIG. 3 is a block diagram of a hardware configuration of the IC card in FIG. 1.

FIG. 4 is a diagram for explaining a certification and a secret key which are stored in the IC card in FIG. 1.

FIG. 5 is a diagram for explaining storage items of the certification base area in FIG. 4.

FIG. 6 is a diagram for explaining a process of structuring a certification management environment of a general user according to the present invention.

FIG. 7 is a flow chart of the certification environment structuring process.

FIG. 8 is a flow chart of a security officer-personal identification number generation process in FIG. 7.

FIG. 9 is a flow chart of a user information character string generation process in FIG. 8.

FIG. 10 is a diagram for explaining a management operation process to a certification management environment of a general user according to the present invention.

FIG. 11 is a flow chart of a management operation process to the user certification management environment in FIG. 10.

FIG. 12 is a flow chart of the security officer-personal identification number generation process in FIG. 11.

FIG. 13 is a flow chart of a security officer-personal identification number generation process according to another embodiment of the present invention.

FIG. 14 is a flow chart of a security officer-personal identification number generation process according to still another embodiment of the present invention.

### DETAILED DESCRIPTION OF THE PREFERRED EMBODIMENTS

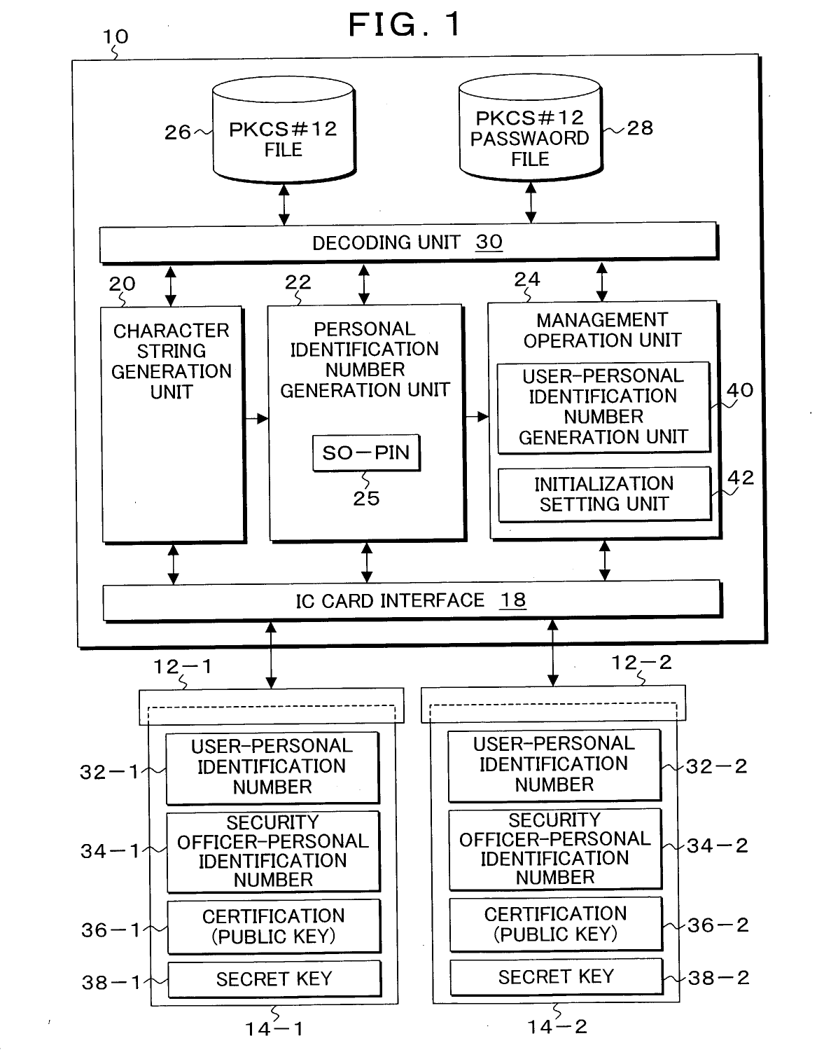

FIG. 1 is a block diagram of a function configuration of a certification management environment maintenance system such as an IC card according to the present invention with reference to an IC card. The certification management environment maintenance system is constituted by a management apparatus 10 realized by a computer held by a manager and IC card adapters 12-1 and 12-2 for connecting, e.g., an IC card serving as a certification management environment managed by the management apparatus 10. In the IC card adaptor 12-1, an IC card 14-1 held by a manager is set as a certification management environment of the manager. In addition to the certification management environment of the manager obtained by the IC card 14-1, the certification management environment of the manager may be realized by a hardware security module (HSM). An IC card 14-2 for realizing a certification management environment of a general user is set in the IC card adaptor 12-2.

Maintenance processes of the IC card by the management apparatus 10 according to the present invention include two processes described as follows:

(1) A certification management environment structuring process of issuing an IC card to a general user.

(2) A management operation process of performing a management operation in response to a request from the general user caused by a trouble of the IC card.

In the maintenance operation of the IC card in the management apparatus 10, according to the present invention, data required for the IC card is stored by a multi-password scheme using a security officer-personal identification number (SO-PIN) and a user-personal identification number (User-PIN). For this reason, in the management apparatus 10, an IC card interface 18, a character string generation unit 20, a personal identification number generation unit 22, a management operation unit 24, a PKCS#12 file 26, a PKCS#12 password file 28, and a decoding unit 30 are arranged. The PKCS#12 file 26, the PKCS#12 password file 28, and the decoding unit 30 are used in a process of structuring a certification management environment of an IC card, and are not used in a management operation for occurrence of trouble after the IC card is issued. In this case, for example, in the manager IC card 14-1 of the IC cards 14-1 and 14-2, a user-personal identification number 32-1, a security officer-personal identification number 34-1, a certification 36-1, serving as a public key, and a secret key 38-1 are stored. In the user IC card 142, specific data is not stored before the process of structuring a certification management environment by the management apparatus 10. In the process of structuring a certification management environment by the management apparatus 10, a user-personal identification number 32-2, a security officer-personal identification number 34-2, a certification 36-2 serving as a public key, and a secret key 38-2 are stored in the IC card 14-2. The character string generation unit 20 of the management apparatus 10 generates a unique user information character string in the process of structuring a certification management environment in the user IC card 14-2. In the generation of the user information character string by the character string generation unit 20, a certification of a user is acquired with reference to the PKCS#12 file 26 and the PKCS#12 password file 28 obtained by the decoding unit 30 and picks up a subject representing a subject name in the certification of the user as a user information character string. As another user information character string, an entire certification may be picked up as a user information character string, or the character string of user information predetermined by the manager may be manually input.

The personal identification number generation unit 22 scribes the user information character string generated by the character string generation unit 20 by coding performed by using the manager secret key 38-1 obtained from the manager IC card 14-1 to generate a security officer-personal identification number ((SO-PIN)) 25. In the generation of the security officer-personal identification number ((SO-PIN)) 25 by the personal identification number generation unit 22, according to a desired embodiment of the present invention, after the user information character string is converted into a hash value by a hash algorithm, signature is performed by coding performed by using the manager secret key 38-1 to generate a security officer-personal identification number 25. As a matter of course, without converting a user information character string into a hash value, a security officer-personal identification number may be directly generated by coding performed by using a manager secret key. The management operation unit 24 logs in to the certification management environment of the user IC card 14-2 by setting the security officer-personal identification number ((SO-PIN)) 25 generated by the personal identification number generation unit 22 to perform a management operation. In this management operation, in the certification management environment structuring process of the user IC card 14-2, the certification 36-2 serving as a public key acquired by the decoding unit 30 from the PKCS#12 file 26 and the PKCS#12 password file 28 and the secret key 38-2 are stored in the user IC card 14-2. In addition, a user-personal identification number forming unit 40 and an initialization setting unit 42 are set in the management operation unit 24.

The user-personal identification number forming unit 40 automatically generates the user-personal identification number 32-2 to be stored in the IC card 14-2 in the certification management environment structuring process of the user IC card 14-2. In a state in which the initialization setting unit 42 uses the security officer-personal identification number ((SO-PIN)) 25 obtained from the personal identification number generation unit 22 to log in to the certification management environment of the user IC card 14-2 in the certification management environment structuring process of the IC card 14-2, after an initialization process is performed, the user-personal identification number 32-2 and the security officer-personal identification number 34-2 which are obtained at this time are stored in the IC card 14-2. As a matter of course, in a management operation for occurrence of trouble after the IC card 14-2 is issued, a new user-personal identification number is automatically generated by the user-personal identification number forming unit 40 as needed, and the user identification number is stored in the IC card 14-2 by the initialization setting unit 42.

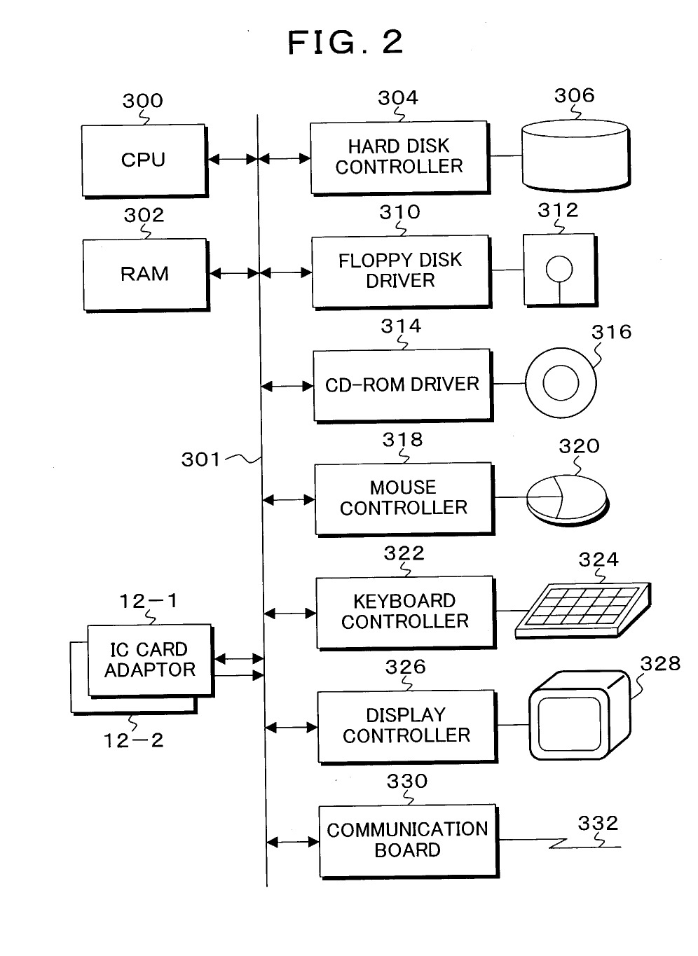

The management apparatus 10 of the certification management environment maintenance system in FIG. 1 is realized by hardware resources of a computer as shown in FIG. 2. In this computer, a RAM 302, a hard disk controller (software) 304, a floppy disk driver (software) 310, a CD-ROM driver (software) 314, a mouse controller 318, a keyboard controller 322, a display controller 326, a communication board 330, and IC card adapters 12-1 and 12-2 are connected to a bus 301 of a CPU 300. The hard disk controller 304 is connected to a hard disk drive 306 and loads an application program for executing a management process of the IC card according to the present invention. A necessary program is called from the hard disk drive 306 at the start of the computer, developed on the RAM 302, and executed by the CPU 300. A floppy disk drive (hardware) 312 is connected to the floppy disk driver (software) 310, so that data can be written in a floppy disk (R). A CD drive (hardware) 316 is connected to the CD-ROM driver 314, so that data or a program stored in a CD can be loaded. The mouse controller 318 transmits an input operation of a mouse 320 to the CPU 300. The keyboard controller 322 transmits an input operation of a keyboard 324 to the CPU 300.

The display controller 326 performs display on a display unit 328. The communication board 330 uses a communication line 332 including a wireless system to communicate with another computer or a server through a network such as the internet. The IC cards of the manager and the general user are loaded on the IC card adapters 12-1 and 12-2, and are accessed by password authentication of personal identification numbers of the manager and the user.

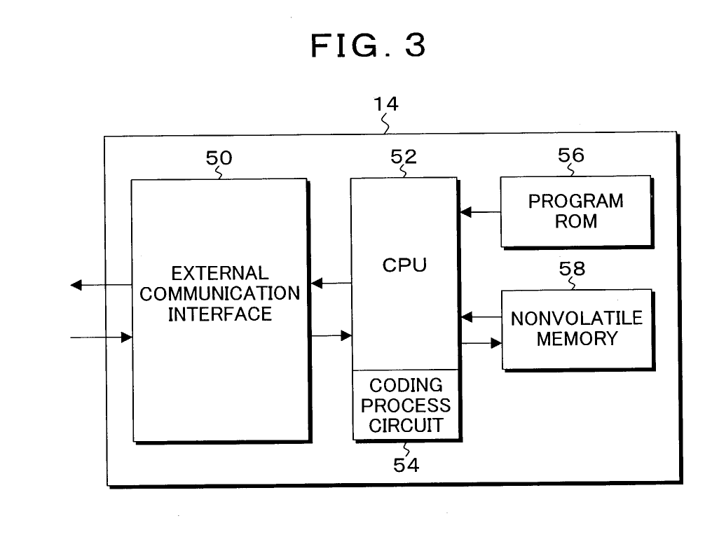

FIG. 3 is a block diagram of the hardware configuration of an IC card 14 which provides a certification management environment serving as an object to be processed by the management apparatus 10 in FIG. 1. The IC card 14 comprises an external communication interface 50, a CPU 52, a coding process circuit 54, a program ROM 56, and a nonvolatile memory 58. The CPU 52 loads the program of the program ROM 56 to execute a process and uses a multi-password scheme which requires a security officer-personal identification number (SO-PIN) and a user-personal identification number (User-PIN) in an external access.

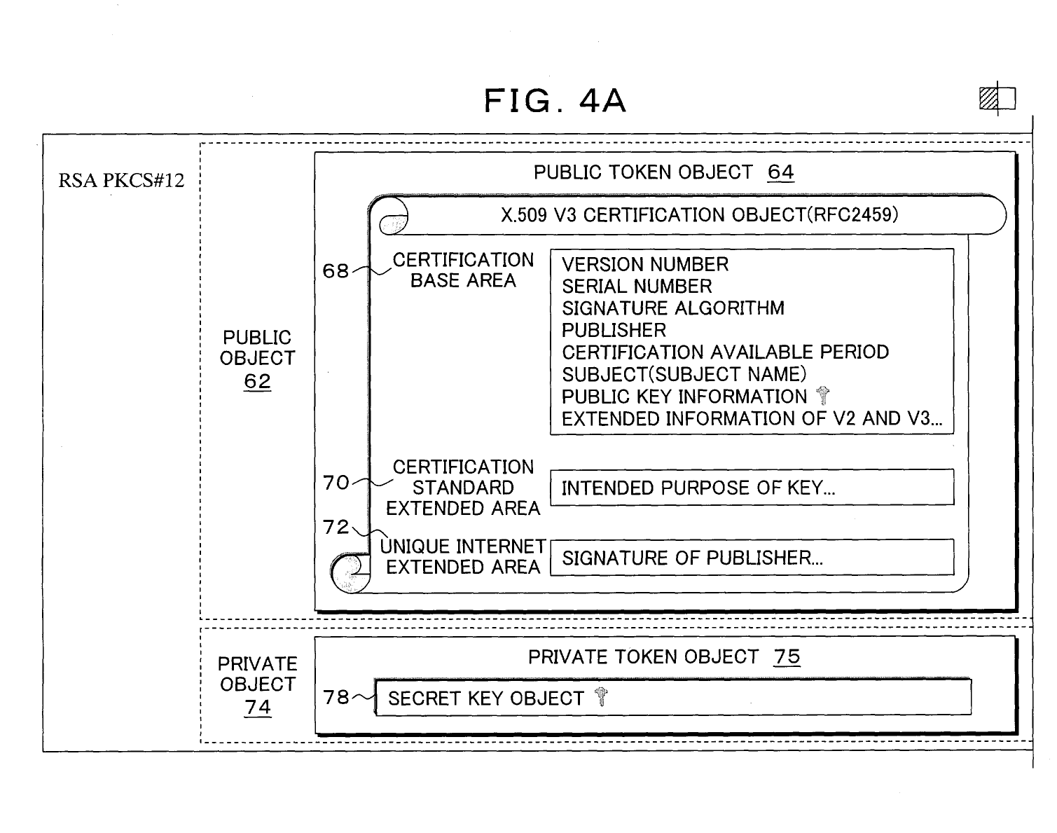

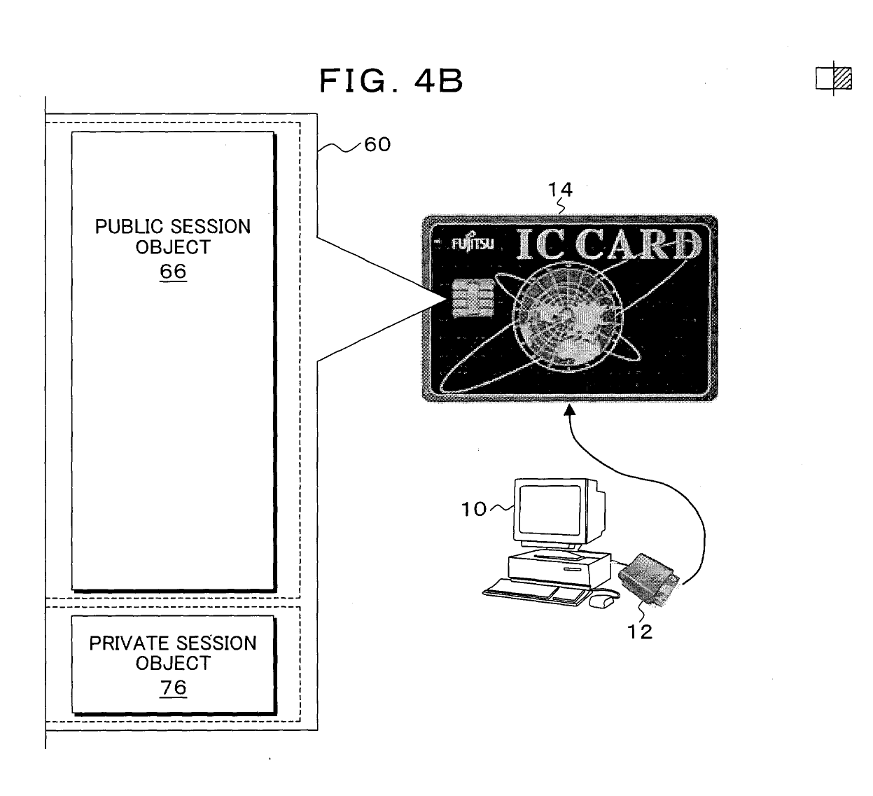

FIG. 4 is a diagram for explaining a storage state of certification data and secret key data which are stored in the nonvolatile memory 58 in the IC card 14 in FIG. 3. The IC card 14 set in an IC card adaptor 12 of the management apparatus 10 is shown by using RSA PKCS#12 as a data storage area 60. The data are separately stored in a public object 62 and a private object 74. The public object 62 corresponds to a storage area of the certification 36-1 in, e.g., the manager IC card 14-1 in FIG. 1, and the private object 74 corresponds to a storage area of the secret key 38-1.

The inside of the public object 62 is divided into a public token object 64 and a public session object 66. The public token object 64 is a nonvolatile area, and the public session object 66 is a volatile area. In the public token object 64, for example, when “X. 509V3 certification object (RFC2459)” is exemplified, a certification base area 68, a certification standard extended area 70, and a unique internet extended area 72 are set. In the certification base area 68, a version number, a serial number, a signature algorithm, an issuer, a certification available period, a subject (subject name), public key information, extended information of V2 and V3, and the like are stored. Of these pieces of information, according to the present invention, a “subject (subject name)” in the certification base area 68 is used as a unique user information character string when a security officer-personal identification number (SO-PIN) is generated. An object for using a key is set in the certification standard extended area 70, and the signature or the like of an issuer is set in the unique internet extended area 72. On the other hand, a private object 74 comprises a private token object 75 serving as a nonvolatile area and a private session object 76 serving as a volatile area. The contents of the private token object 75 of these objects serve as a secret key object 78. With respect to the public object 62 of the data storage area 60 of the IC card 14, in a multi-password scheme according to the present invention, a read/write operation can be performed by log-in authentication by the security officer-personal identification number (SO-PIN). In contrast to this, to the private object 74, a read/write operation can be performed by log-in authentication of the user-personal identification number (User-PIN).

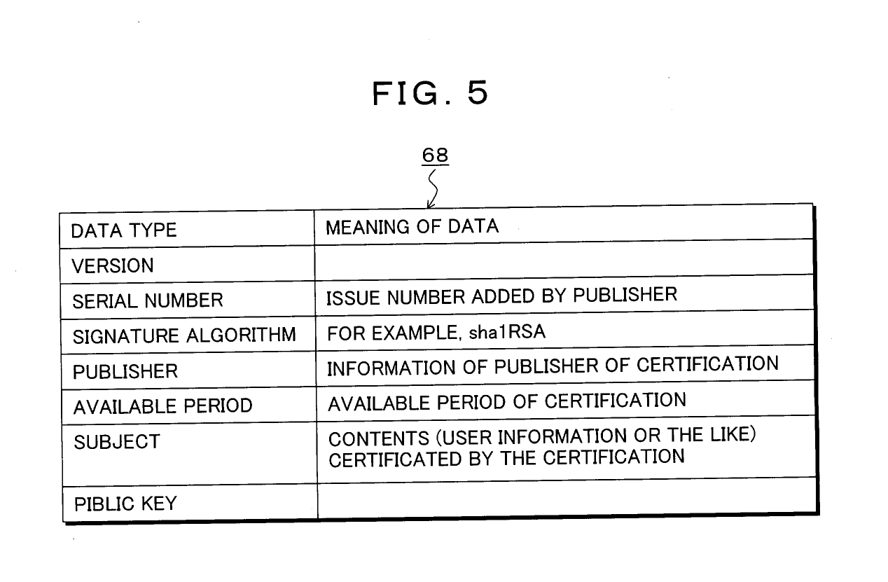

FIG. 5 explains the meanings of main items set in the certification base area 68 set in the public token object 64 in FIG. 4. More specifically, the version, serial number, signature algorithm, issuer, available period, subject, and public key of the certification base area 68 are picked up. As the version, a predetermined version is described. The serial number is an issue number added in an issue source.

The signature algorithm is, e.g., “sha1RSA”. In this case, “sha1” is one of hash functions (digest functions) used in authentication, digital signature, and the like. Pseudo random numbers (hash values) of 160 bits are generated from a text having 2⁶⁴ bits or less, and these values are compared at both the ends of data access, so that it can be detected whether the text is interpolated in the middle of transmission or not. The “RSA” is an RSA algorithm code. Therefore, the signature algorithm “sha1RSA” in this case performs coding by the RSA algorithm after the text is hashed by the sha1. The next issuer describes information of the issue source of the certification. As the available period, the available period of the certification. As the subject, contents certificated by the certification, more specifically, user information or the like is described. In the present invention, “Subject DN” serving as a subject name in the subject is used as a user information character string.

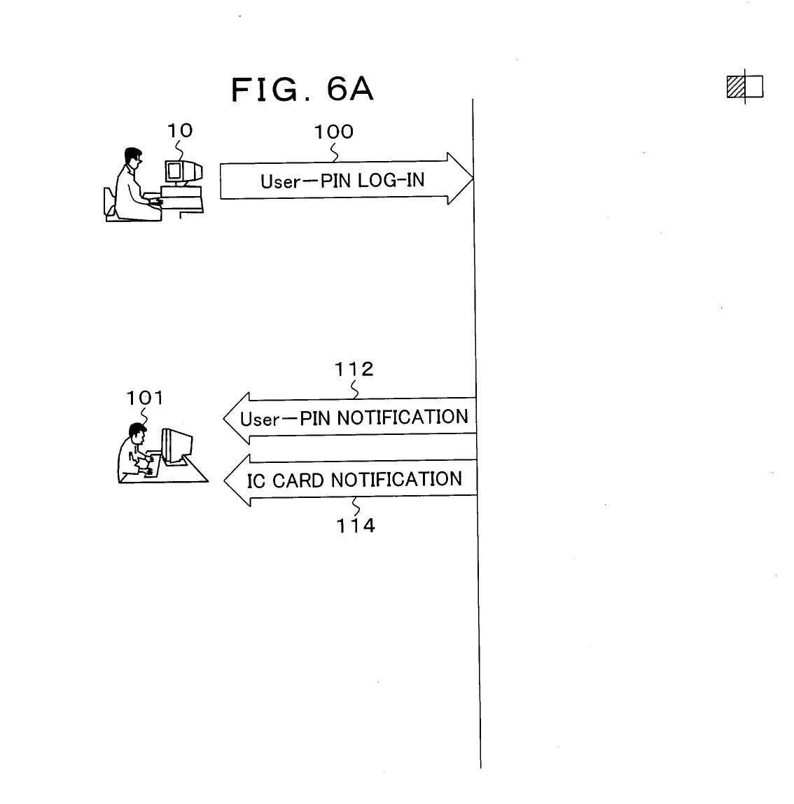

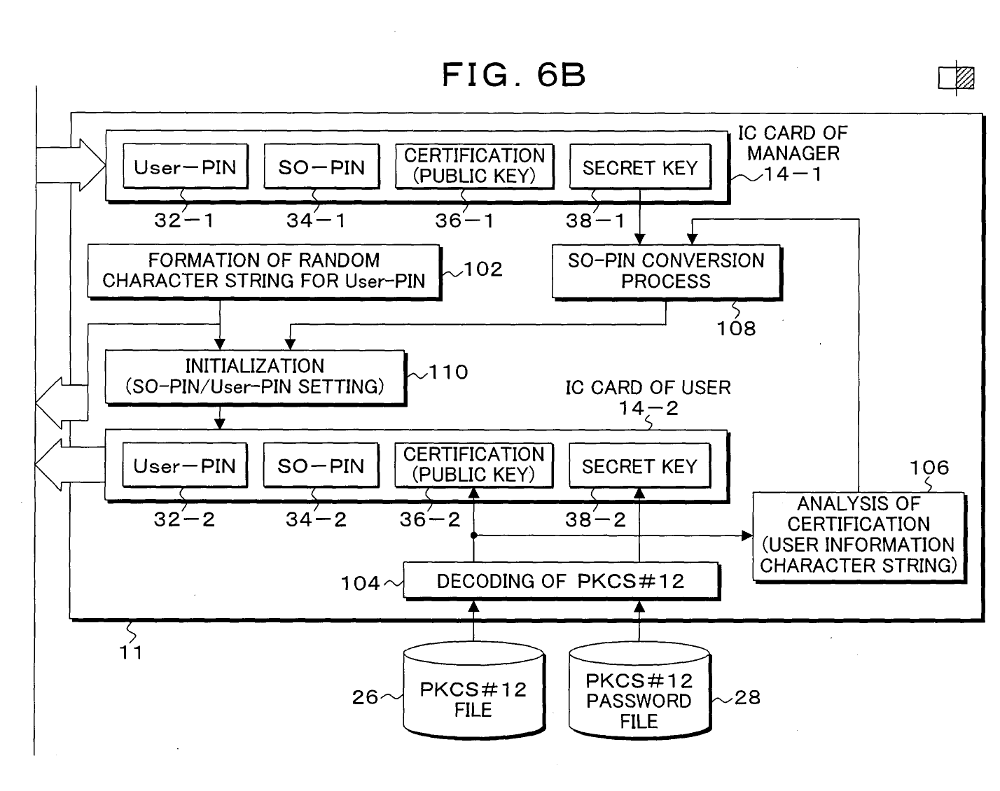

FIG. 6 is a diagram for explaining the process of structuring a certification management environment with respect to an IC card of a general user according to the present invention. In a certification management environment structuring process for issuing an IC card, the following preparing processes are performed.

(1) Like a certificating person identification name (Subject DN) of a certification to be distributed to a general user, a user information character string which can uniquely specify a certification management environment is prepared.

(2) A certification of a general user using the prepared user information character string is issued.

(3) The issued certification is separated into a PKCS#12 file and a PKCS#12 password file to be managed.

(4) An empty user IC card subjected to a physical logical format is set in an IC card adaptor.

FIG. 6 shows a certification management environment structuring process of issuing an IC card the preparing operations of which are completed to a general user. Since a manager 101 must access a certification management environment obtained by the manager IC card 14-1 set in the IC card adaptor, as in a process 100, the manager 101 logs in by the user-personal identification number 32-1 of the manager. Subsequently, in a process 102, by using a function of forming a password random character string, a user-personal identification number (User-PIN) set in the IC card serving as a certification management environment of a general user. A security officer-personal identification number ((SO-PIN)) to be stored in the user IC card 14-2 is automatically generated. In the automatic generation of the security officer-personal identification number ((SO-PIN)), the PKCS#12 file 26 and the PKCS#12 password file 28 for the general user which are formed on the preparation stage in advance are loaded in a process 104, and the PKCS#12 file is decoded to pick a certification. This certification has the contents of, e.g., the public token object 64 shown in FIG. 4. In a process 106, the picked certification is analyzed, and a “subject (subject name)” included in the certification base area 68 of the public token object 64 in FIG. 4 is extracted. The “subject (subject name)” is used as a user information character string. In a process 108, a hash algorithm of, e.g., sha1 is applied to the user information character string obtained by the analysis in the process 106 to form a hash value, and coding is performed by using the secret key 38- 1 obtained from the manager IC card 14-1 to generate signature data.

For example, an RSA algorithm coding secret key is obtained as the secret key 38-1 of the manager IC card 14-1. The hash value obtained by the process of the hash algorithm of sha1 from the user information character string by using the secret key to generate signature data. Since the signature data generated in this manner is a hexadecimal numeral, after the signature data is converted into a character string, characters the number of which is equal to the number of characters of the security officer-personal identification number, i.e., ranges 4 to 15 or 6 to 15 are cut from the converted character string to generate a manager identification information character string ((SO-PIN)). A procedure for cutting or less characters from the character string converted from the signature data is as follows when 15 characters are cut:

(1) 15 characters from the start;

(2) 15 characters from the end;

(3) 15 odd-number-th characters;

(4) 15 even-number-th characters; and

(5) 15 characters selected according to a specific rule. The cut characters are set as a security officer-personal identification number (SO-PIN). If necessary, a hash value is further set for the security officer-personal identification number cut in this manner. Subsequently, after a certification management environment of the IC card 14-2 of a general user is initialized in a process 110, the user-personal identification number (User-PIN) formed in the process 102 and the security officer-personal identification number (SO-PIN) formed in the process 108 are set as the user-personal identification number (User-PIN) 32-2 and the security officer-personal identification number (SO-PIN) 34-2 in the certification management environment of the IC card 14-2 of the general user.

A certification (public key) decoded by loading the PKCS#12 file 26 and the PKCS#12 password file 28 in the process 104 is picked and written in the certification management environment of the IC card 14-2 of the general user. More specifically, a certification (public key) is written as the public token object 64 in the public object 62 in the data storage area 60 in FIG. 4 and serves as a certification (public key) 36-2 in the IC card 14-2 of the general user in FIG. 6. Similarly, the secret key obtained by decoding in the process 104 is picked and written in the certification management environment of the IC card 14-2 of the general user by the authority of the user-personal identification number (User-PIN) to serve as the secret key 38-2. More specifically, the private token object 75 of the private object 74 in the data storage area 60 in FIG. 4 is written. In this manner, upon completion of the structuring process for the certification management environment of the IC card 14-2 of the general user, the manager 101 logs out from a certification management environment maintenance system 11, and the user IC card 14-2 is removed from the IC card adaptor and distributed to a general user 201. The manager 101 notices the user-personal identification number (User-PIN) 32-2 stored in the user IC card 14-2 to the general user 201 through a route different from those of the IC card 14-2. The process of structuring a certification management environment for the IC card of the general user as shown in FIG. 6 is performed such that applications of general users are totalized to prepare empty IC cards the number of which corresponds to the number of applications. The user information character string used to generate the security officer-personal identification number (SO-PIN) set in a card issued by the structuring process in FIG. 6 is registered in a directory server in the same organization as that of the certification management environment maintenance system 11 to be disclosed.

The user information character string can be referred and used when a management operation is performed when trouble occurs in the IC card.

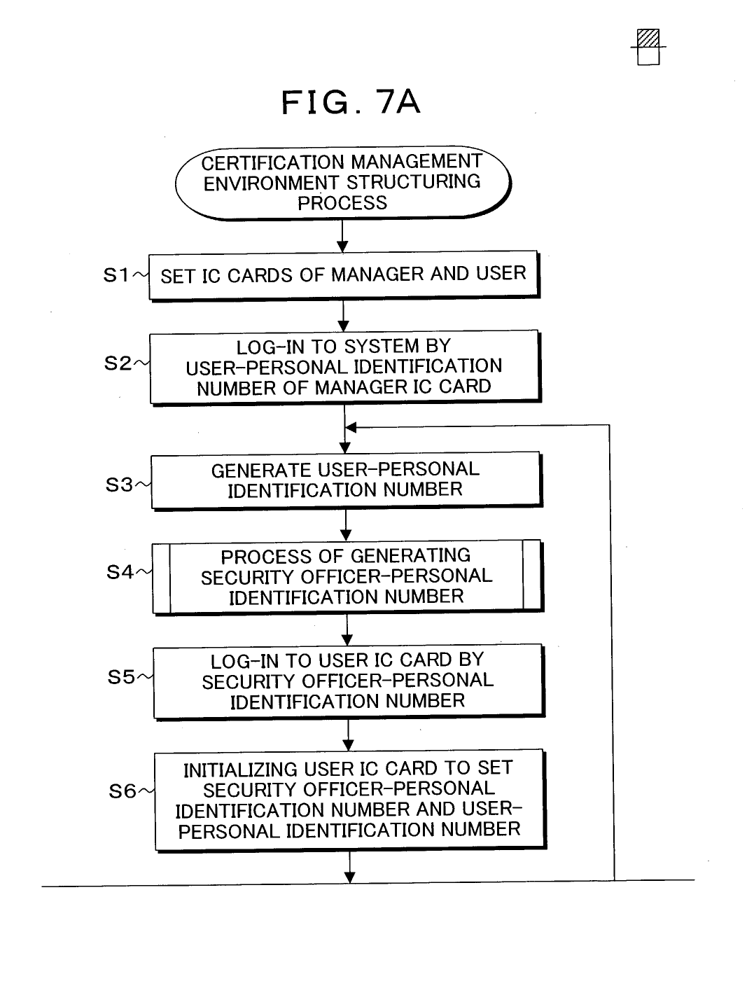

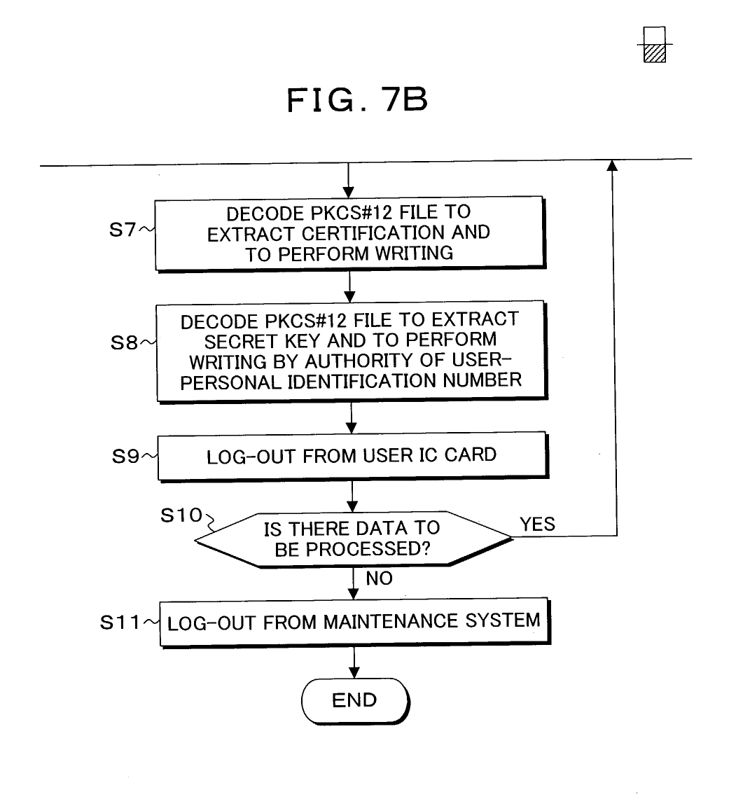

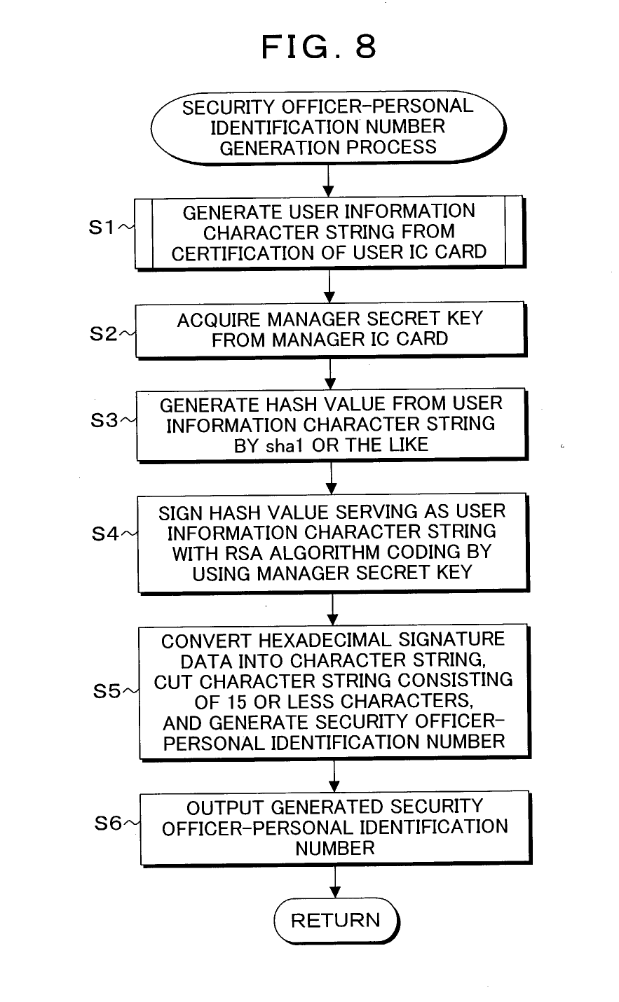

FIG. 7 is a flow chart of a certification management environment structuring process in FIG. 6. This flow chart shows a program of the certification management environment structuring process according to the present invention. When the manager IC card 14-1 and the user IC card 14-2 are set in the IC card adapters in step S1, an input is accepted by using the user-personal identification number (User-PIN) 32-1 of the manager IC card 14-1 as a password in step S2, so that the certification management environment maintenance system 11 executes a log-in process to the manager. In step S3, a user-personal identification number (User-PIN) to be stored in the IC card 14-2 of a general user is formed by using a function of forming a random character string as in the process 102. Step S4, a process of generating a security officer-personal identification number to be stored in the user IC card 14-2. The detailed description of the process of generating a security-officer-personal identification number is shown in the flow chart in FIG. 8 as a sub-routine.

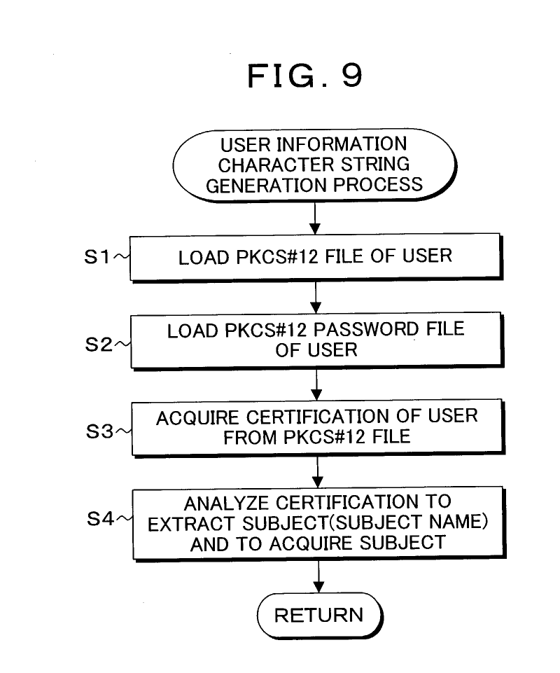

In the security officer-personal identification number generation process in FIG. 8, a character string of user information is generated from a certification stored in the user IC card 14-2 in step S1. More specifically, although the character string is generated by loading and decoding the PKCS#12 file 26 and the PKCS#12 password file 28 in the process 104 in FIG. 6, the details of this process are shown in FIG. 9 as a sub-routine of the user information character string generation process. That is, in the user information character string generation process in FIG. 9, the PKCS#12 file 26 of the user is loaded in step S1, the PKCS#12 password file 28 of the user is loaded in step S2, and a certification (public key) of the user is obtained from the PKCS#12 file in step S3. In addition, the certification acquired in step S4 is decoded to extract a subject (subject name) of the user, and the subject is acquired as a user information character string.

Returning to FIG. 8, when the user information character string can be generated in step SI, the secret key 38-1 is acquired from the manager IC card 14-1 in step S2. In step S3, a hash value is generated from by sha1 serving as a hash function from the user information character string generated in step S1. The hash value obtained as the user information character string in step S4 is scribed by coding performed by an RSA algorithm using the secret key 38-1 of the manager acquired in step S2 to generate signature data. After hexadecimal signature data is converted into a character string in step S5, a character string having characters the number of which is required as the number of characters of the security officer-personal identification number (SO-PIN), e.g., 15 or less characters is cut to generate a security officer-personal identification number (SO-PIN). In step S6, the security officer-personal identification number (SO-PIN) is output.

Returning to FIG. 7, when the security officer-personal identification number (SO-PIN) can be generated according to the sub-routine in FIG. 8 in step S4, a log-in process to the certification management environment of the user IC card 14-2 is performed by the security officer-personal identification number (SO-PIN) in step S5, the security officer-personal identification number (SO-PIN) 34-2 generated after the user IC card 14-2 is initialized in step S6 and the user-personal identification number (User-PIN) 32-2 generated in step S3 are set. The PKCS#12 file 26 is decoded in step S7, the certification (public key) of the user is picked and written in the IC card 14-2 as the certification (public key) 36-2. The PKCS#12 file 26 is decoded in step S8 to pick a secret key. The secret key is written in the IC card 14-2 as the secret key 38-2 by the authority of the user-personal identification number (User-PIN) 32-2, i.e., password authentication. In step S9, log-out from the certification management environment of the user IC card 14-2 is performed in step S9. When there is unprocessed data in the IC card of the general user in step S10, the control flow returns to step S3 to repeat the same process as described above. When there is no unprocessed data in the user IC card, a log-out from the certification management environment maintenance system 11 is performed in step S11, and a series of certification management environment structuring process.

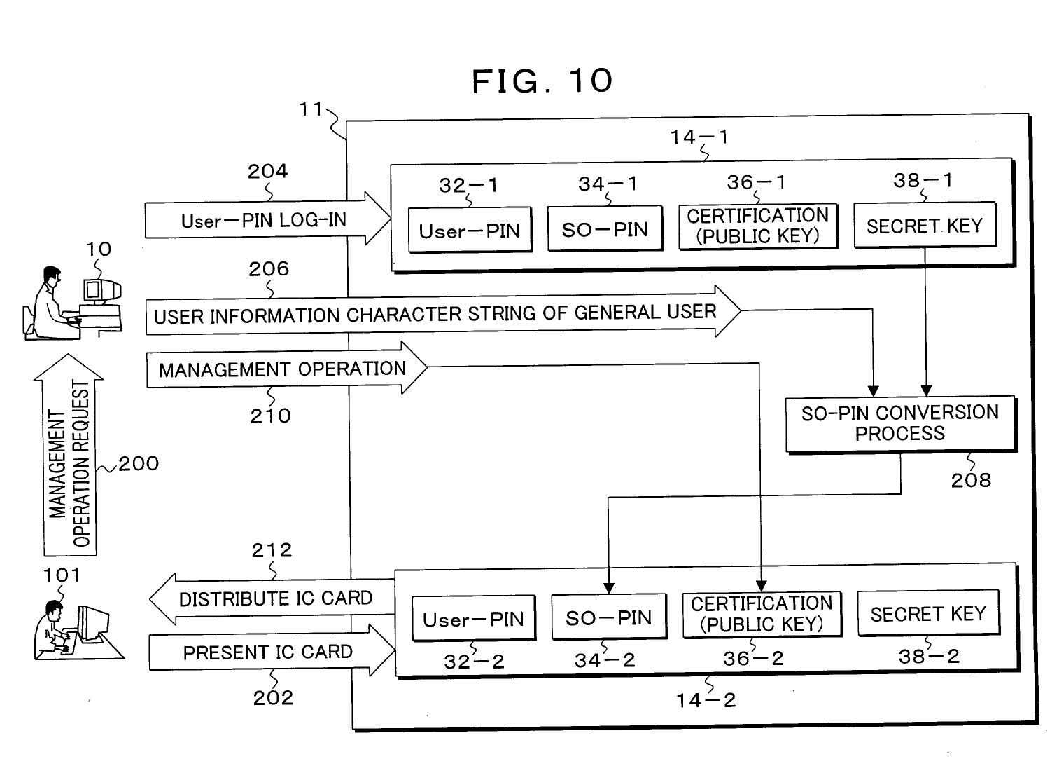

FIG. 10 is a diagram for explaining a management operation process for reissuing an IC card when a trouble occurs in an IC card issued to a general user by the certification management environment structuring process in FIG. 6, e.g., when a general user cannot use an IC card by losing the user-personal identification number (User-PIN) of the IC card. When a trouble occurs in the IC card 14-2 held by the general user, the general user 201 requests a manager to perform a management operation as in a process 200, presents the IC card to the certification management environment maintenance system 11 as in a process 202, and sets the manager IC card 14-1 and the user IC card 14-2 in the IC card adapters 12-1 and 12-2 of the management apparatus 10 as shown in FIG. 1. The management apparatus 10 logs in to the certification management environment maintenance system 11 by password authentication performed by the user-personal identification number (User-PIN) 32-1 of the manager IC card 14-1. The management apparatus 10 sets the user information character string of the user IC card 14-2 subjected to the management operation in the process 206. Since the user information character string with respect to the IC card which has been issued by the structuring process in FIG. 6 is registered in the directory server or the like in the same organization as that of the certification management environment maintenance system 11 and disclosed, the management apparatus 10 accesses the directory server by the personal information of the user to acquire a user information character string. When the user information character string acquired as described above is set by the manager 101 in the process 206, a hash algorithm of sha1 is applied to the user information character string to acquire a hash value in a process 208. Thereafter, the hash value is scribed by an RSA algorithm coding scheme performed by the secret key 38-1 acquired from the manager IC card 14-1 to generate signature data. Since the signature data is a hexadecimal numeral, after the signature data is converted into a character string having characters the number of which is 15 or less is cut as in the certification management environment structuring process in FIG. 6. The character string is output as the security officer-personal identification number (SO-PIN), and a log-in process to the certification management environment of the user IC card 14-2 is performed by the authority of the security officer-personal identification number (SO-PIN). Subsequently, the manager performs a management operation to the user IC card 14-2 in which a trouble occurs as in a process 210. For example, when the general user loses the user-personal identification number (User-PIN) 32-2 of the user IC card 14-2, a new user-personal identification number (User-PIN) is generated by using the function of forming a random character string in the process 102 shown in the structuring process in FIG. 6, and the user-personal identification number (User-PIN) is newly set in the IC card 14-2 as the user-personal identification number (User-PIN) 32-2. A fault occurs in the certification (public key) 36-2 or the secret key 38-2, as in the case of the structuring process in FIG. 6, a new certification (public key) and a new secret key are acquired by decoding the PKCS#12 file 26 and the PKCS#12 password file 28 and written in the user IC card 14-2. In this manner, upon completion of the management operation for the user IC card 14-2 in which the trouble occurs, a logout process from the IC card 14-2 and the certification management environment maintenance system 11 is performed, the IC card 14-2 which is restored is returned to the general user 201. At this time, when the general user loses the user-personal identification number (User-PIN), a user-personal identification number (User-PIN) of the IC card 14-2 which is changed when data is stored is noticed to the general user through another path.

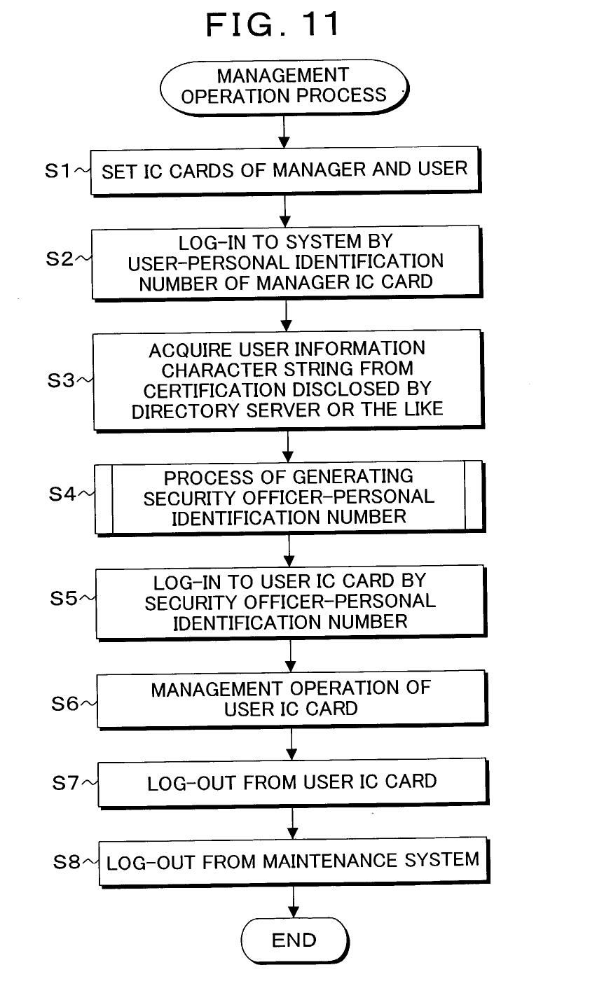

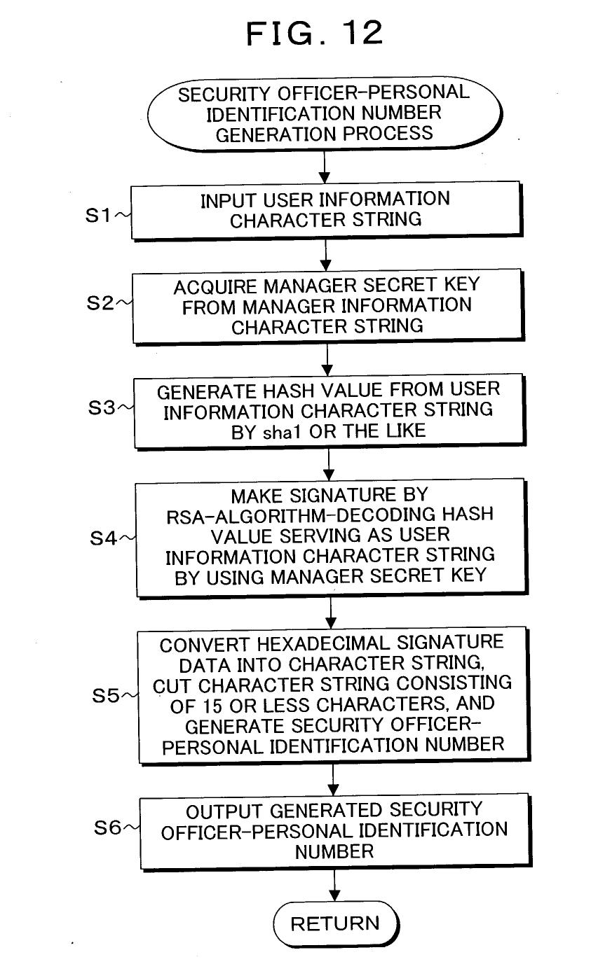

FIG. 11 is a flow chart of a management operation process to a user certification management environment in FIG. 10, and shows a management operation process program according to the present invention. In the management apparatus 10 which is requested by a general user with respect to an IC card in which a trouble occurs, the manager and user IC cards 14-1 and 14-2 are set in the IC card adapters 12-1 and 12-2 as shown in FIG. 1, and a log-in process to the certification management environment maintenance system 11 is performed by password authentication performed by the user-personal identification number (User-PIN) of the manager IC card 14-1 in step S2. In step S3, a user information character string is acquire d from a certification disclosed by a directory server or the like. A process of generating a security officer-personal identification number is performed in step S4. The details of the process of generating a security officer-personal identification number are shown as a sub-routine in FIG. 12.

The security officer-personal identification number generation process in FIG. 12 is the same as the certification management environment structuring process shown in FIG. 8 with respect to the processes in steps S2 to S5 except that a manager inputs an object (subject name) of a certification acquired with reference to a directory server or the like in step S1 as a user information character string.

Returning to FIG. 11, when the security officer-personal identification number (SO-PIN) is generated in step S4, a log-in process to the user IC card 14-2 by password authentication performed by using the security officer-personal identification number (SO-PIN) in step S5, and a management operation of the user IC card 14-2 is performed in step S6. Upon completion of the management operation, after a log-out process from the user IC card 14-2 in step S7, a log-out process from the certification management environment maintenance system 11 in step S8, and the series of operations is ended.

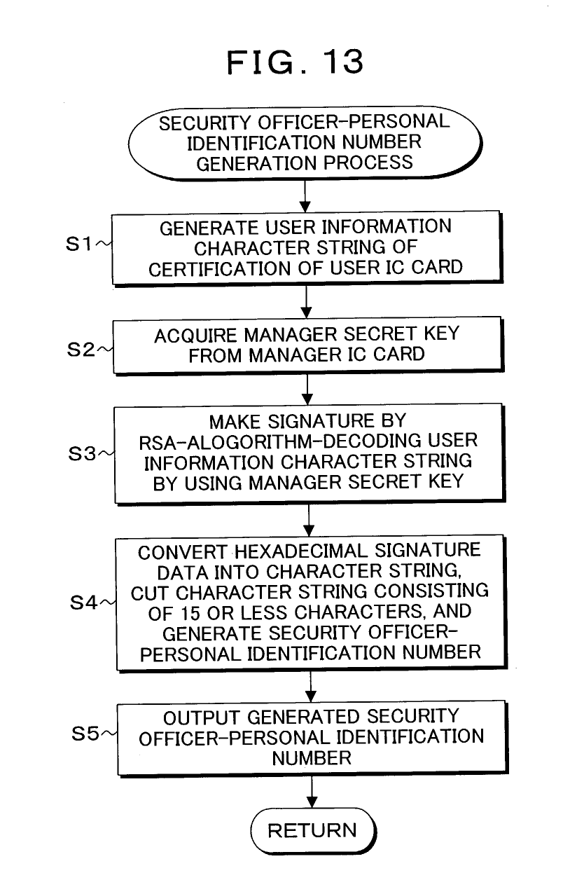

FIG. 13 shows another embodiment of a security officer-personal identification number generation process in the certification management environment structuring process shown in FIG. 8. This embodiment has a characteristic feature in which a hash process of a user information character string is not performed. More specifically, when a user information character string is generated from a certification of a user IC card in step S1, a hash value is generated in FIG. 8. However, in the embodiment, the secret key 38-1 of the manager IC card 14-1 is acquired without generating a hash value in step S2, and signature data is generated by coding the user information character string by an RSA algorithm using the secret key 38-1 in step S3. The signature data is converted into a character string in step S4 to cut a character string having 15 or less characters.

The character string is generated as a security officer-personal identification number and outputs in step S5.

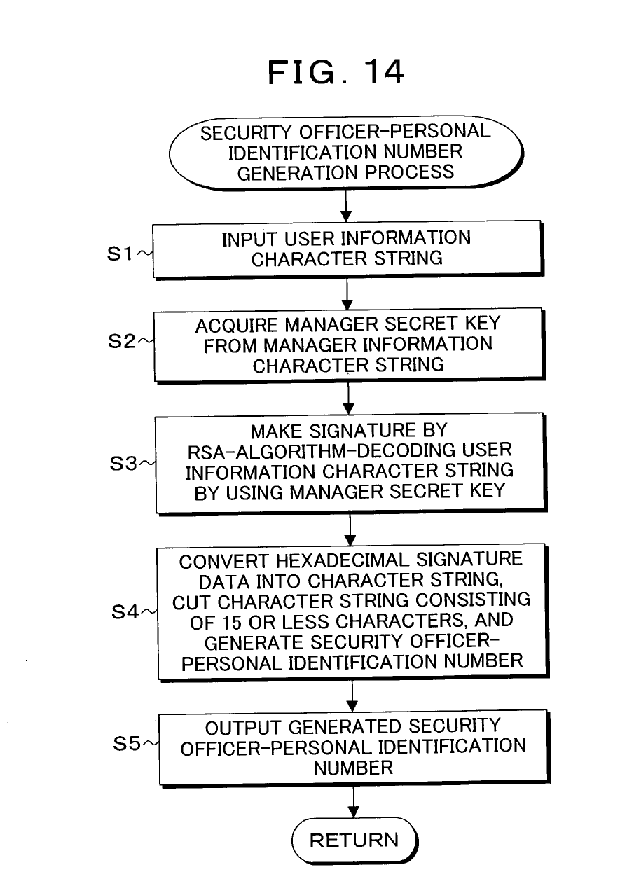

FIG. 14 shows still another embodiment of a security officer-personal identification number generation process. This embodiment has the following characteristic feature. That is, a user information character string is not acquired from an object (subject name) of a certification of a user, a user character string input by a manager according to a predetermined rule is accepted in step S1. As a user information character string input to the management apparatus 10 in step S1, for example, four pieces of information of a user are input. The four pieces of information include “name”, “birth date”, “sex”, and “address”. In this manner, a unique user information character string can be easily generated by the four pieces of information of the user. As a matter of course, the user information character string using the four pieces of information need not be input by a manager, and the user information character string may be automatically input by extracting the four pieces of information from the management file of the user. The processes in steps S2 to S5 subsequent to the input of the user information character string in step S1 are the same as those in the embodiment in FIG. 13. As still another embodiment of a security officer-personal identification number generation process, a security officer-personal identification number (SO-PIN) may be generated by using a certification (public key) of a user itself as a user information character string.

As described above, according to the present invention, since a security officer-personal identification number (SO-PIN) is automatically generated as a unique character string from signature data using a unique user information character string and a secret key of a manager, management of security officer-personal identification numbers (SO-PIN) the number of which must be equal to the number of IC cards of users is not necessary when the manager structures certification management environments such as IC cards. At the same time, the manager need not directly manage the security officer-personal identification numbers themselves, and the manager may manage only the IC cards and a hardware security module (HSM) such that only a secret key held in the certification management environment of the manager is prevented from being exposed. For this reason, even though the number of structured certification management environments such as IC cards changes, a security officer-personal identification number can be easily properly managed without lowering the security level. In addition, when the manager performs a management operation by the authority of the manager in a certification management environment such as an IC card of a general user, i.e., when the manager performs a structuring process or a management process for a certification management environment, a security officer-personal identification number is automatically generated by selecting only personal information of a general user serving as an object to be processed. A log-in process to the certification management environment of the user is performed, and these processes are automatically performed on memories of all computers. For this reason, the security officer-personal identification number need not be manually input. At the same time, even the manager can perform the management operation without knowing the security officer-personal identification number. Therefore, the security officer-personal identification number can be reliably prevented from being exposed.

In the above embodiments, an IC card held by a manager is exemplified as a certification management environment of the manager. However, a certification management environment realized by a hardware security module (HSM) used by the manager may be applied. Furthermore, in the present invention, PKCS#12 is exemplified as files of a certification (public key) and a secret key described in the above embodiments. However, other forms of a certification (public key) and a secret key may be referred to. The hash algorithm used in generation of a security officer-personal identification number (SO-PIN) and coding performed by a secret key are not limited to the sha1 and the RAS algorithm described in the above embodiments. The present invention includes appropriate modifications without departing from the objects and advantages of the invention, and is not limited by numerical values described in the embodiments.

What is claimed is:

1. A method of managing a certification management environment of a user in which a certification and a secret key are stored, comprising:
the character string generation step of generating a unique user information character string by a character string generation unit; and
the personal identification number generation step of subscribing the user information character string by coding performed by using a manager secret key by a personal identification number generation unit to generate a security officer-personal identification number.

2. A method according to claim 1, further comprising the management operation step of accessing the certification management environment by setting the generated security officer-personal identification number by the management operation unit.

3. A method according to claim 1, wherein, in the character string generation step, a user identification character string is generated on the basis of a user certification extracted from a preset user certification file.

4. A method according to claim 3, wherein, in the character string generation step, a subject representing a subject name in the user certification extracted from the preset user certification file is picked up as the user information character string.

5. A method according to claim 3, wherein, in the character string generation step, the user certification itself extracted from the preset user certification file is generated as the user information character string.

6. A method according to claim 1, wherein, in the character string generation step, an input predetermined character string is generated as the user information character string.

7. A method according to claim 6, wherein, in the character string generation step, a character string of four pieces of information constituted by the input name, birth date, sex, and address of a user are generated as the user information character string.

8. A method according to claim 1, wherein,
in the character string generation step, a hash value is generated by a predetermined hash algorithm from the user information character string, and
in the personal identification number generation step, the hash value is subscribed by coding performed by using a manager secret key to generate a security officer-personal identification number.

9. A method according to claim 1, wherein, in the personal identification number generation step, after the generated signature data is converted into a character string, a character string having a predetermined number of characters is cut from the converted character string to generate a security officer-personal identification number.

10. A method according to claim 2, wherein, in the management operation step,
a log-in process to a certification management environment of the user is performed by the authority of the security officer-personal identification number, initialization is performed, and the security officer-personal identification number and a user-personal identification number which is generated in advance are set in the certification management environment, and a certification and a secret key of the user acquired by decoding a preset file are stored by the authority of the user-personal identification number (User-PIN) in the certification management environment to perform a log-off process.

11. A method according to claim 10, wherein, in the management operation step, a certification and a secret key of the user acquired by decoding a preset PKCS file and a preset PKCS password file are stored in the certification management environment to perform a log-off process.

12. A method according to claim 1, wherein The certification management environment of the user is an IC card in which a security officer-personal identification number, a user-personal identification number, a user certification, and a user secret key are stored.

13. A program for managing a certification management environment of a user in which a certification and a secret key are stored, wherein the program causes a computer to execute:
the character string generation step of generating a unique user information character string; and the personal identification number generation step of scribing the user information character string by coding performed by using a manager secret key to generate a security officer-personal identification number.

14. A management apparatus for managing a certification management environment of a user in which a certification and a secret key are stored, comprising:
a character string generation unit for generating a unique user information character string; and
a personal identification number generation unit for scribing a user information character string by coding performed by using a manager secret key to generate a security officer-personal identification number.
